(19) United States
(12) Patent Application Publication
(10) Pub. No.: US 2014/0188974 A1
(43) Pub. Date: Jul. 3, 2014

(54) SYSTEM AND METHOD FOR ORCHESTRATING MASSIVELY DISTRIBUTED CONTENT DELIVERY NETWORKS

(71) Applicant: THOMSON LICENSING, Issy de Moulineaux (FR)

(72) Inventors: Efstratios IOANNIDIS, San Francisco, CA (US); Laurent MASSOULIE, Vaucresson (FR); Fabio PICCONI, Paris (FR); Wenjie JIANG, Princeton, NJ (US)

(73) Assignee: THOMSON LICENSING, Issy de Moulineaux (FR)

(21) Appl. No.: 13/727,635

(22) Filed: Dec. 27, 2012

(51) Int. Cl. H04L 29/08

(52) U.S. Cl. CPC H04L 67/1078
USPC 709/202

(57) ABSTRACT

An apparatus and method are provided for tracking and positioning content within a domain including a plurality of devices that provide content data to users. The apparatus and associated method include a communication interface that receives requests for content from respective ones of the plurality of devices. An optimization processor analyzes all requests for each piece of content, and determines at least one of an actual request rate and a target request rate for each piece of content and, in response to the determination of the actual and target request rates, instructs individual devices of the plurality of devices to store respective pieces of content in a memory.

### FIELD

The present arrangement provides a system and method for mass distribution of content to a plurality of users via a communications network, and more specifically, to organizing content on networked devices to facilitate content requests in an efficient and least costly manner.

### BACKGROUND

The total Internet traffic per month was already in excess of 10¹⁹ Bytes in 2011. Video-on-demand traffic alone is predicted to grow to three times this amount by 2015. Existing content providers such as YOUTUBE® and NETFLIX®, which represent a large fraction of today's Internet video traffic, use content delivery networks (CDNs) to replicate, cache, and stream videos at many servers across the world. Nevertheless, the large volumes of traffic exiting the CDN infrastructure incur significant operational costs for the content providers. This state of affairs prompts a rethinking of the current content delivery architecture.

CDNs are networks of interconnected computing devices that allow users of these devices to request content from a content provider. Peer-assistance of CDNs has shown that it can reduce CDN server traffic and energy consumption by more than 60%. The reduction of transaction costs for fulfilling user requests for content is highly desirable. Certain mechanisms for achieving this cost reduction have been tried. These cost reduction mechanisms include prefetching policies for peer-assisted Video on Demand (VoD) whereby certain content data is acquired and stored in advance of a user request on a device of another user (e.g. a peer user). Another mechanism used in the attempt to reduce cost is allocating bandwidth across different Peer-to-Peer (P2P) swarms. Peer incentivization, e.g., through rebates or service fee reductions, has also been attempted. Moreover, the use of dedicated home devices as an extension of a CDN's infrastructure has also been attempted. However, a drawback associated with this extension model relates to the joint placement of user devices and routing optimization currently employed by these systems.

A further issue associated with CDNs relates to cross-traffic. Minimizing cross-traffic is extensively studied in the context of “ISP-friendly” P2P system design and is known to reduce both ISP cross-traffic and download delays. Typically, the selection of download sources is biased towards nearby peers and peer proximity can be inferred either through client-side mechanisms or through a service offered by the ISP. In the latter case, the ISP can explicitly recommend which neighbors to download content from by solving an optimization problem that minimizes cross-traffic. In the context of peer-assisted CDNs, an objective that minimizes a weighted sum of cross-traffic and the load on the content server can also be considered. Prior work on ISP-friendliness reduces cross traffic solely by performing service assignment to suitable peers. However, a drawback associated with this mechanism for minimizing cross-traffic is that it is incomplete and only focuses on routing of the content to requesting users.

Another mechanism employed to reduce transaction costs in a CDN is based on the concept of cooperative caching. In the cooperative caching problem, clients generate a set of requests for items that need to be mapped to caches that can serve them. Each client/cache pair assignment is associated with an access cost. The goal is to decide how to place items in caches and assign requests to caches that can serve them so that the total access cost is minimized. Certain algorithms exist that attempt to achieve this goal. For example, when looking at CDN topologies, on mechanism obtains lower approximation ratios as well as competitive online algorithms for the case where cache costs are determined by weights in a star graph. Another mechanism is a polynomial algorithm used in the case where caches are organized in a hierarchical topology and the replica accessed is always the nearest replica. However, a drawback associated with these mechanisms is that they concentrate on aspects of the CDN unrelated to those that impose the actual costs for delivering the requested content.

Furthermore, while the concept of cache management in the context of P2P VoD systems, and is in this sense close to our work. A significant drawback associated with current cache management system relates to their inability to be implemented on heterogeneous (e.g., across multiple ISPs) networks

### SUMMARY

In one embodiment, a device for tracking and positioning content within a domain including a plurality of devices that provide content data to users. The device includes a communication interface that receives requests for content from respective ones of the plurality of devices. An optimization processor analyzes all requests for each piece of content, and determines at least one of an actual request rate and a target request rate for each piece of content and, in response to the determination of the actual and target request rates, instructs individual devices of the plurality of devices to store respective pieces of content in a memory.

In another embodiment, a method of tracking and positioning content within a domain including a plurality of devices that provide content data to users. The method includes receiving requests for content from respective ones of the plurality of devices; analyzing all requests for each piece of content; determining at least one of an actual request rate and a target request rate for each piece of content; and instructing individual devices of the plurality of devices to store respective pieces of content in a memory in response to the determination of the actual and target request rates.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is an illustrative view of the system according to invention principles;

FIG. 2 is a block diagram of a gateway device according to invention principles; and

FIG. 3 is a block diagram of a tracker device according to invention principles.

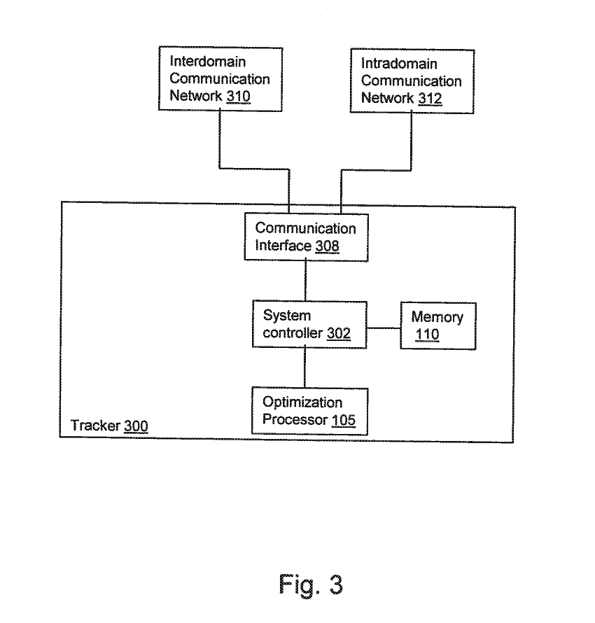

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

As used in this application, the terms “component” and/or “module” are intended to refer to hardware, or a combination of hardware and software in execution. For example, these elements can be, but are not limited to being, a process running on a processor, a processor, an object, an executable running on a processor, and/or a microchip and the like. By way of illustration, both an application running on a processor and the processor can be a component or a module. One or more components and/or modules can reside within a process and may be localized on one system and/or distributed between two or more systems. Functions of the various components and/or modules shown in the figures can be provided through the use of dedicated hardware as well as hardware capable of executing software in association with appropriate software.

The present invention provides a system and method for aiding the distribution of content data from a content delivery server to home users through the use of set-top boxes at each user location as peer relay servers. As used herein, the term content data is understood to mean audio-video data for display on a display device. Content data may also be any type of data in any data format that imposes a high cost on a network over which the content data is transferred. The set-top boxes may function as gateways which provide and control access between a user's location and a communication network such as the internet. Thus, throughout the following description, the terms set-top box and gateway may be used interchangeably. However, these terms are used for purpose of example only. The term set-top box and/or gateway is intended to describe any computing device at a user's location that controls access to a content delivery network and which stores and services content requests from other users. The system advantageously leverages the storage of each set-top box to efficiently store (e.g. cache) content able to be requested by a user as well as fulfill user requests for content in a manner that minimizes costs to the network and reduces an amount of time between content request and the delivery of that request to the user. The system advantageously determines which content from a library of content provided by the content provide to cache at which set-top-boxes and to which set-top-boxes a respective request for content should be routed.

In another embodiment, a gateway may not be the terminal connection point between a user and the CDN. Rather, the gateway may be positioned at some point in the communication network between at least one user and the content provider server.

Gateways may advantageously be used as relays or storage devices to store content data provided by a content provider and which is distributed to requesting users via a CDN. Each gateway may include a dedicated portion of memory set aside for storing content data to be accessed by users at locations remotely located from the gateway. This results in the user being able to request and receive content data (e.g. a movie) from a source other than directly from a content provider server. In one embodiment, the user may request content and the request may be fulfilled by another user's gateway within a predetermined cluster of gateways on which the content is stored. Thus, the system advantageously alleviates or otherwise minimizes traffic on the CDN's servers and over communication (e.g. ISP) networks. Reducing traffic over communication networks is particularly advantageous for content providers because the content providers typically pay for the use of the communication networks.

Furthermore, accessing locally stored or cached movies also reduces the CDN's cost for providing the content data to each user. The leveraging of gateway/set-top boxes at user locations further advantageously results in cost savings because the content provider server from which all content in a content library is selectively distributable can be a smaller server cluster then would otherwise be needed if all requests for content need to be fulfilled directly by the content provider's server.

The system further advantageously reduces an amount of time it takes for requested content to be delivered to the requesting user. The use of distributed local storage of content accessible via a local network reduces any potential delay associated with accessing the content data because local access is superior to remote server access.

A key advantage provided by the present system is that the system determines where content data is to be stored locally amongst a group of users (e.g. a domain). The system further advantageously determines a number of replications of a particular piece of content data is to be distributed amongst the users within the domain in order to efficiently fulfill subsequent user requests without dropping these requests. The system further determines and allocates requests and fulfillments efficiently in view of the limited bandwidth typically associated with a respective gateway. Thus, the present system advantageously minimizes the costs associated with distributing content data to a plurality of users.

Therefore, the architecture of the present system has considerable advantages for both providers as well as users. First, it harnesses available bandwidth and storage resources of appliances already deployed at users' locations (e.g. homes/businesses). Second, it enables serving requests locally from a device within a common networked domain (e.g. an entity that is managed by a single administrator such as an ISP) or even within a predetermined geographical area. In addition to reducing latency, the system alleviates CDN server traffic while also reducing cross-traffic among different domains thereby significantly decreasing the operational cost of the CDN. Thus, a content provider may deploy the present system in conjunction with the traditional CDN architecture to optimize performance and reduce cost simultaneously.

The present system achieves the cost minimization goal using an optimization algorithm that includes identifying what content to cache in each gateway and identifying which gateway is to serve an incoming request for content. Moreover, as each gateway has limited resources, the storage and bandwidth constraints of each gateway are need to be taken into account in the above optimization. Additionally the system takes into account a demand associated with each piece of content being provided by the CDN in order to determine optimal placement (e.g. storage) of respective pieces of content and the routing decisions required for distributing the content to requesting users. For example, to reduce traffic costs, it is preferable to cache content closer to where it is most frequently requested.

Thus, the present system advantageously employs a joint optimization algorithm that considers both content data storage and request routing together with one another because both decisions impact each other. Additionally, the present system is scalable over a plurality of different networked domains wherein each domain has a significant number (e.g. >1 million) of gateway devices associated therewith This advantageously enables the system to operate in a heterogeneous networked environment that include domains administered by multiple different administrative entities (e.g. multiple ISPs). The present system further provides adaptive placement and routing schemes for respective content data that automatically react to changes in user demand for each piece of content data.

In the following description of the architecture of the inventive system and its operation, the notation listed in Table 1 includes certain elements of the system and will facilitate understanding thereof.

TABLE 1
Summary of key notation

| | |
|---|---|
| s | Existing CDN infrastructure. |
| [symbol] | Set of all boxes in the system. |
| [symbol] | Content catalog. |
| D | Set of all set-of-box classes. |
| [symbol] ^{d} | Boxes in class d ε_{D}. |
| M^{d} | Storage capacity of boxes in [symbol] ^{d}. |
| U^{d} | Upload capacity of boxes in [symbol] ^{d}. |
| [symbol] _{b} | Cache content of box b. |
| p_{c}^{d} | Replication ratio of content c in [symbol] ^{d}. |
| λ_{c}^{d} | Request rate for content c ε [symbol] in [symbol] ^{d}. |
| w^{dd′} | Cost of a transfer from d′ε_{D}∪ {s} to d ε_{D}. |
| r_{c}^{dd′} | Rate of requests for c forwarded from d ε _{D}to d′ε_{D}∪{s}. |
| r_{c}^{.d} | Aggregate rate of incoming requests for c to d ε_{D}. |
| R^{d} | R^{d} = B^{d}U^{d}, the total upload capacity in class d. |

[symbol]

indicates data missing or illegible when filed

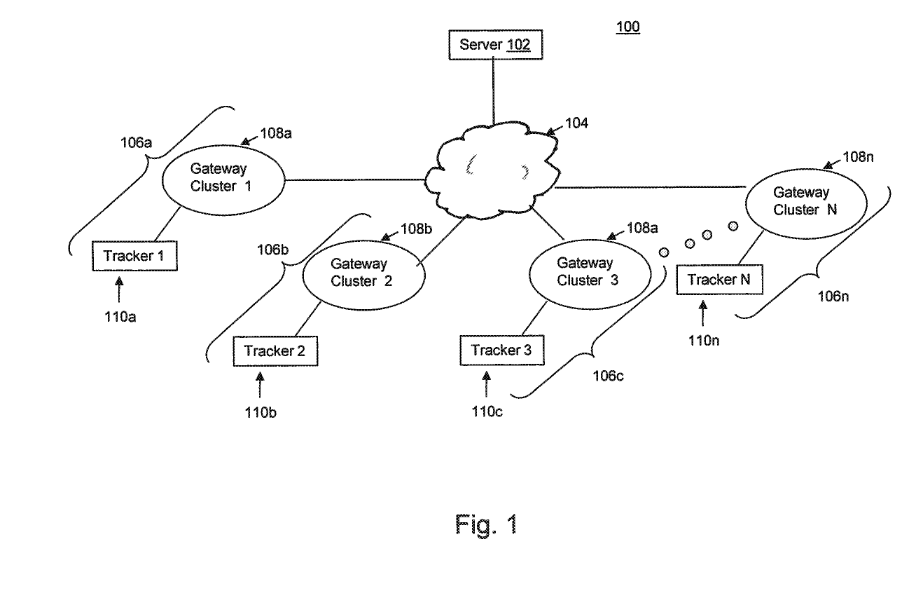

Referring now to FIG. 1 which represents an illustrative view of the system detailing the interconnections between various components and devices used to implement the present system. FIG. 1 represents an illustrative view of a content delivery network 100 that is serviced by a single content provider server 102. This depiction of a single content provider and single content provider network is described for purposes of example only and one skilled in the art understands that the principles described herein may be implemented in a networked environment wherein the same individual users are serviced by multiple different content providers each managing their own content provider network simultaneously.

The CDN server 102 is coupled to a plurality of user domains 106a-106n via a communications network 104. The domains 106a-106n may be managed by different administrative entities or by a single administrative entity. Each domain 106a-106n includes a respective gateway cluster 108a-108n that includes a class of individual users each having at least one respective gateway device associated with the individual users. In one embodiment, each gateway cluster 108a-108n may include between 1,000 and 10,000 gateway devices. In another embodiment, the gateway clusters 108a-108n may represent a predetermined geographical region (e.g. a few city blocks, a small town). In a further embodiment, the gateway cluster 108a-108n may be local (e.g., an adjacent city block) or remote (e.g. a first class in LA and a second class in Chicago). Within each domain 106a-106n, a tracker device 110a-110n is provided for managing the gateway cluster 108a-108n to which it is connected. The tracker device 110a-110n tracks the activity of the individual users in the class as well as the sub-networks and/or gateways devices. The tracker device 110a-110n tracks which gateway devices are in the class, which gateway devices are on or off, the content stored on each gateway device, and if gateway device is busy or not (i.e. how many concurrent uploads each box is serving at the moment such that a predetermined number of concurrent uploads for a particular gateway device is not exceeded). In one embodiment, the predetermined number of concurrent uploads for each gateway device in a respective gateway cluster 108a-108n may not exceed 5.

Additionally, as will be discussed below, each tracker device 110a-110n may selectively communicate with respective other tracker devices 110a-110n to send and receive information about the respective gateway devices in their respective gateway cluster 108a-108n. This advantageously enables each tracker device to more efficiently distribute content within its own cluster 108a-108n and minimize cross-traffic costs when attempting to fulfill requests.

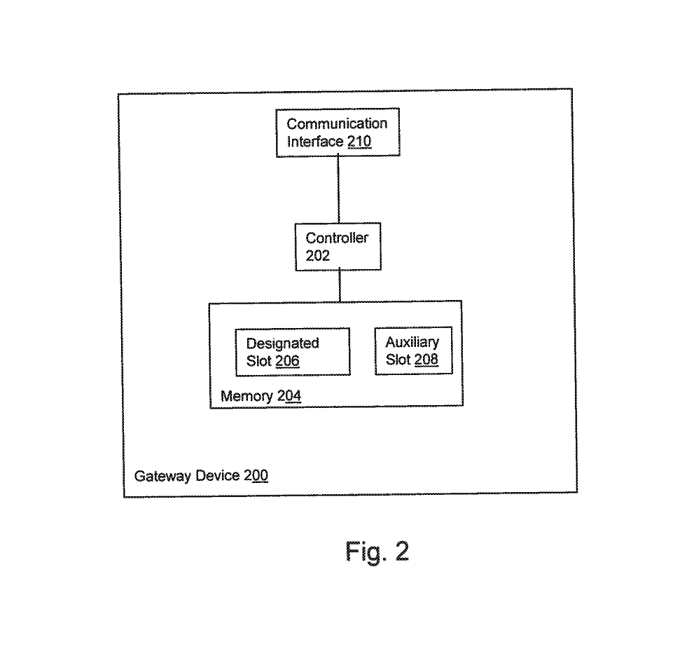

FIG. 2 is a block diagram of an exemplary gateway device 200 (or set top box) associated with a respective user of the present system. The gateway device 200 enables the user to selectively request, acquire and view content data from a content provider. In one embodiment, the gateway device 200 is a set top box that is provided by a cable television provider and selectively enables a user to tune one or more channels on which content is transmitted. In this embodiment, the set top box may enable the user to request Video on

Demand services from the cable provider whereby the cable provider is serving as the content provider 102 as shown in FIG. 1. This is described for purposes of example only and the gateway device 200 may be any device that enables a user to selectively request, acquire, process and output content data to be consumed by a user (e.g. viewing on a television).

The gateway device 200 includes a gateway controller 202 that executes instructions controlling system operation. The gateway device 200 further includes a memory module 204 having a predetermined amount of storage for storing data thereon. The memory 204 may store any type of data need to perform any system function. However, the discussion of the memory module 204 will be limited to its use within the present system. The memory module 204 includes a first partition 206 that represents a designated slot for storage of content data. The memory module 204 further includes a second partition 208. The second partition 208 may include at least one auxiliary slot for storing other content data therein. The number and size of the second partition 208 of the memory module is only limited by the bit size of the particular memory module 204 in the gateway device 200. As will be discussed below, the division of the memory module into the first partition having a designated slot and the second partition 208 having at least one auxiliary slot is key to the efficient optimization for storage of respective content data as well as fulfilling specific requests for content data.

A gateway device communication interface 210 is provided and is coupled to the controller 202. The communication interface 210 selectively controls access to a communications network (104 in FIG. 1). In exemplary operation, the communication interface 210 selectively transmits and receives requests for respective content data. The communication interface 210 further enables requests for particular content data stored in the memory module 204 to be fulfilled by providing an upload link to a remotely located requesting user. The communication interface 210 of the gateway device further enables the gateway device 200 to receive content data that is to be stored in the memory module 204 (either in the first partition 206 of second partition 208) that may be used to fulfill user requests for the particularly stored content data.

While a single gateway device 200 is shown in FIG. 2, one skilled in the art of massively distributed content distribution networks will under stand that a plurality of gateway devices are distributed amongst a plurality of users. An exemplary description of a large scale deployment may include the following.

We represent the users' gateway device 200 by a set β, the set of boxes, where B=|β|. We partition β into D classes βd, d ∈ρ={1, . . . ,D}, with size Bd=|βd|. Such partitioning may correspond to grouping together boxes managed by the same administrative entity (e.g. ISP). Different levels of aggregation or granularity may also be used. For example, each class may comprise boxes within the same city or even the same city block. Throughout the text, we use the index d for a class in ρ and the index s (as in “server”) to indicate the existing CDN infrastructure. Through the CDN, boxes gain access to the provider's content data collection, such as, e.g., movies, clips or shows. We denote this collection by :and call it the content catalog. We assume that items in have identical size—if not, the original content can be partitioned into fixed-size chunks such that the items are of identical size and [symbol] is viewed as a collection of chunks. Classes of users are heterogeneous such that storage and bandwidth capacities as well as traffic costs associated with serving requests differ across different classes. Nevertheless, boxes within the same class have the same capacities and incur the same costs. .

Part of the boxes' storage (e.g. memory 204) is allocated to and managed by a tracker device (110a-110n) of the CDN. Each box in β^{d} has M^{d} storage “slots”, used by the CDN to store content items. We call M^{d} the storage capacity of boxes in βd. For each b ∈β^{d}, we denote the set of items cached in box b by [symbol] ⊂c, where | [symbol] |=M^{d}. Note that [symbol] b is determined by the CDN, not the user. Users may store (or delete at will) content they retrieve in private storage devices, or even at the spare storage of their box, but such replicas are not managed or shared by the CDN.

Gateway devices 200 can serve incoming requests received via the communication interface 210 for content they store in this designated space within memory module 204. The constraints placed on the gateway device 200 may be such that a box in [symbol] can upload at most U^{d} content items concurrently, each at a fixed rate. We refer to U^{d} as the upload capacity of boxes in class d. Alternatively, each box has U^{d} upload “slots”. If a box receives a request for a content it stores and has a free upload slot, this slot is used to serve the request and upload the requested content. The service time, i.e., the duration of an upload, is assumed to be exponentially distributed with one-unit mean. Slots remain busy until the upload terminates, at which point they become free again.

Gateway devices associated with particular users generate content requests at varying rates across different classes. We model requests for content c generated by each box b ∈β^{d} throu a Poisson process with rate [symbol] . Hence, the aggregate request process for c in class d is also Poisson with rate λ_{c}^{d}= [symbol] B^{d}, which scales proportionally to the class size. When a box b ∈β^{d} storing c ∈c (i.e., c ∈ [symbol] ) generates a request for c, it is served by the local cache—no downloading is necessary. Otherwise, the request must be served by either the CDN's pre-existing infrastructure or some other box in β.

Serving a user request from class d using either the existing CDN infrastructure or another class d′ requires transferring content across the class boundaries. In general, cross-traffic costs are dictated by the transit agreements between peering ISPs and may vary from one class to the next. As such, we denote by w^{dd′}, d,d′∈ [symbol] the traffic cost for serving a request from class d by a box in class d′. Similarly, we denote by w^{ds} as the traffic cost of serving a request from class d by the CDN's existing infrastructure.

The content provider that manages the boxes pays incurred cross-traffic costs to ISPs. Hence, it is in its interest to minimize such costs. In particular, the service provider needs to determine (a) the content [symbol] placed in each box b, and (b) where the request generated by each box should be directed to, so that its aggregate traffic costs are minimized.

Solving this problem over millions of devices, while satisfying the constraints imposed by the limited storage and bandwidth capacities at each box, poses a significant scalability challenge. Further, deciding where to place content and how to route requests is, in general, a computationally intractable combinatorial problem. In addition, managing boxes from different ISPs raises the need for a distributed solution that does not require the ISPs to reveal their internal structure to each other. Finally, the optimal placement and routing scheme depends on the demands λ_{c}^{d}; these may dynamic and a priori unknown to the CDN. As such, an adaptive scheme, that measures and reacts to user demand, is preferable. The present system addresses these challenges as discussed below.

FIG. 4 is a block diagram of an exemplary tracking device 300 which implements a distributed, adaptive scheme for joint placement and routing of content data from a content provider to various users of a CDN. The tracker device 300 is deployed by the content provider, either as separate servers or as designated boxes within each class. The tracker device 300 manages a class of respective user gateway devices. The tracker device 300 manages (a) content placement within their gateway devices of their particular class of users and (b) the routing of requests either generated or served by user gateway devices in their classes.

The tracker device 300 includes a system controller 302 that controls the operation thereof and a memory 301 for storing data therein. A communication interface 308 is coupled to the system controller and selectively provides bidirectional communication via an interdomain communication network 310. An interdomain communication network 310 may be, for example, the internet. The interdomain communication network couples respective different class tracking devices associated with respective different domains each having their own users to one another. The communication interface 308 further enables bidirectional communication between the tracker device 300 and respective gateway devices (200 in FIG. 2) within the domain being managed by the tracker device 300.

The tracker device 300 includes an optimization processor 304 that implements a content optimization algorithm that intelligently optimizes the manner in which content is stored between all respective gateway devices in the particular class or domain. The optimization processor 304 operates under the principle that that if the arrival rates for requests are not greater than threshold as compared to how many gateway devices within a domain store desired content data, the optimization processor 304 is able to determine a placement for all content such that all requests for the content may be fulfilled. Thus, if a sum of arrival rates for all files is less than total upload capacity of all gateway devices within one class and the number of arrival request for a particular content data is less than the total fulfillment capacity (e.g. number of upload links) of the boxes that store the content, the optimization processor 304 will be able determine a placement policy such that the content may be stored in various gateway devices of the current domain and most requests for the content data will be satisfied and not dropped (e.g. not fulfilled by a gateway device in another domain or directly fulfilled by the content provider). The content placement policy places content in the gateway devices use the global optimization algorithm which dynamically increase replication rate or decrease requests sent to ISP based on information obtained from other gateway devices and other tracking devices associated with other domains.

In one embodiment, the tracker device 300 identifies the predetermined number of storage slots in all gateway devices within its domain. The tracker designates one storage slot as a designated slot such that the number of designated slots of a particular domain equals the number of gateway devices in that domain. The tracker designates at least one other slot in each gateway device as an auxiliary slot able to store additional pieces of content data. The content data stored in the designated slot and the at least one auxiliary slot may be the same content data or may be different. Alternatively, the same content data may be stored in both the designated slot and auxiliary slot while additional different content data is also stored in the auxiliary slot as well.

Respective content data is replicated and stored in a number of designated slots of a number of gateway devices proportionally to the request rate for the respective content data. The tracker device 300 further places additional copies of the respective content in the auxiliary slots such that the number of auxiliary stored content data equals a target request rate for the respective content.

The optimization processor 304 executes an iterative process over a (e.g., once an hour, two hours or six hours) where class tracker device 310 communicates congestion signals with other class trackers via the interdomain communication network 310. The class tracker then uses the congestion signals to adapt “replication ratio” and “forwarding rate” parameters. More specifically, the class tracker determines a number of files (e.g., copies of a content data) that should be stored amongst the respective gateway devices 200 in the class (e.g. domain). The optimization processor 304 further determines a fraction of requests from gateway devices in its own class that should be forwarded to other classes or to the CDN server via the interdomain communication network 310. In other words the tracker 310, based on the congestion signals received from other trackers that manage other domains, determines replication ratios for each content data (e.g., movie file) and determines forwarding rates (fraction of requests within class that goes to another class, the CDN server, etc.). For example, based on the congestion signals a tracker may determine that 25% of requests are served by gateways in the tracker's class, 35% of requests are forwarded to a neighboring class, 20% of requests are forwarded to a remote class and the remaining 20% of requests are sent to the CDN server. The process is iterative because the type of content and demand for the content will change over time (e.g., in response to the release of new movies).

Once the optimization processor 304 determines that a number of internal requests are going to be served by gateway devices within the tracker's class, other classes or the CDN server, the optimization processor determines and implements a routing policy to handle all incoming requests from gateway devices of the particular class or domain. This is accomplished by identifying incoming requests from other trackers of other domains and determining if gateway devices in the current class have the requested content data and are available to upload the content data (e.g. free upload slots to service the request). The optimization processor 304 may signal the controller 302 to forward the request via the intradomain communication network 312 to available gateway device within the domain. If there is no gateway device that has requested content data stored thereon or if the gateway device(s) having the content are unavailable due to lack of upload slots available, the controller 302 will forward the unfulfilled request to a CDN server via the interdomain communication network 310.

The optimization processor 304 may further use the determined parameters from the gateway devices within the managed domain as well as from other domains to adaptively modify the type and number of copies of different content from the content catalog of the content provider stored on the various gateway devices in the respective domain managed by the tracker device 300. Thus, as trackers develop replication ratios and forwarding rates, through self adapting corrective behavior, the entire CDN system will come to rest at the lowest cost for the content provider. Also, the probability of the rerouting of requests will decrease towards zero because the continually iterative storing of content in gateway devices will enable a more efficient request fulfillment operation from within the respective domain thereby reducing system traffic and cost due to cross talk.

The following description is an exemplary operation of the optimization processor 304 of the tracker 300. Each tracker has a full view of the state of the boxes (e.g. gateway devices) within its class and knows the contents of each box's cache (e.g. what content data is stored) and the number of its free upload slots. Nevertheless, the tracker does not have access to the same information about boxes in other classes. In fact, its knowledge about the state in other classes is limited to lightweight congestion signals exchanged periodically between trackers which will be discussed hereinafter.

For each content c ∈ [symbol] , the tracker maintains the desirable replication ratio p_{c}^{d}, which is the fraction of boxes in the class that store [symbol] . In addition, the tracker also maintains the desirable forwarding rates r_{c}^{dd′}, d′∈ [symbol] ∪ {s}, which correspond to the rate of outgoing requests for [symbol] , forwarded to other class trackers as well as the CDN infrastructure (denoted by s). These variables are stored locally in the memory of the tracker and updated periodically at fixed time intervals (e.g., once every day). The updated values are used as inputs to the tracker's placement and routing algorithms within the next adaptation round that determines whether or not the placement of the content data need be adjusted based on requests for each piece of content. Updating these variables allows the trackers to adapt both their placement and routing decisions, in a way that the system reaches a global objective (namely, the minimization of aggregate costs).

At the termination of each adaptation round, after deciding the replication ratios p_{c}^{d} of each content item in class d, the tracker allocates the content items to boxes within the class such that for each box b ∈ [symbol] , the tracker determines [symbol] in a manner so that the fraction of boxes storing c is indeed p_{c}^{d}. The trackers are also responsible for routing requests either generated or served by boxes in their classes. We separate the routing of requests into two phases: request forwarding and service assignment. Request forwarding determines to which class a request generated by a local box is forwarded, so that the desirable forwarding rates r_{c}^{dd′}are maintained. Upon receiving a request, the tracker of the class selects a box within its class to serve the request; we refer to this selection as service assignment.

We turn now to the optimization performed by optimization processor 304. As stated above, each class tracker has a complete view of the current state of every box inside its own class. In particular, it knows (a) which content items are stored in each box, and (b) how many free upload slots it has. The trackers also collect traffic statistics. The class d tracker maintains estimates of λ_{c}^{d}, c ∈ [symbol] the rate with which requests for content c are generated within the class. It also maintains estimates of the incoming rate of requests for content c in class d. All the above are measured and maintained locally at the tracker; this is possible precisely because it manages both content placement and request routing within its class. Nevertheless, trackers are a-priori unaware the states of boxes in other classes: they learn about congestion in other classes through the exchange of appropriate light-weight congestion signals, at the end of each adaptation round.

In addition to the above information pertaining to their classes, trackers maintain | [symbol] | local variables p_{c}^{d} ∈ [0, 1], for c ∈ [symbol] ,d ∈ [symbol] . We call p_{c}^{d} the replication ratio of item c in class d, and the vector p^{d}=[p_{c}^{d}]_{c∈}, the replication policy of class d. At any point in time, the replication ratios satisfy Equation 1:

$$\text{?} \text{?} \text{indicates text missing or illegible when filed} \qquad ( 1 )$$

such that the replication ratio p_{c}^{d} equals the fraction of boxes in [symbol] that store content c ∈ [symbol] . Also, by summing Equation (1) in terms of c, it is advantageously enables the system to identify when all caches of all gateway devices in the domain are full as provided in Equation 2.

$$\text{?} \text{?} \text{indicates text missing or illegible when filed} \qquad ( 2 )$$

The replication policy of a tracker serves as an input to its content placement algorithm executed by the optimization processor 304. That is, the tracker updates a replication policy (or, its desired replication ratios) at the end of every adaptation round. Subsequently, the replication policy is used to determine the placement of content to boxes in [symbol] so that Equation 1 is satisfied.

In addition to its replication policy, the tracker maintains (| [symbol] |+1)× [symbol] additional local variables

$$\text{?}$$

$$\text{?} \text{indicates text missing or illegible when filed}$$

These are termed the forwarding rates of class d, and the vector

$${r}^{d} = [ {r}_{c}^{dd ′} ] {d}^{′} ∈ \text{?} \{ s \} \text{?}$$

$$\text{?} \text{indicates text missing or illegible when filed}$$

of these values represents the forwarding policy of d. At any point in time each variable r_{c}^{dd′} ∈ [symbol] , for d′∈ [symbol] equals the rate of requests for content c that the tracker forwards from class d to d′. Similarly, each variable r_{c}^{ds} ∈ [symbol] equals the rate of requests for c forwarded by the tracker directly to the CDN's existing infrastructure. The forwarding policies satisfy the equalities in Equation 3 which provides:

$$\text{?} - \text{?} \text{?} = \text{?} - \text{?} \\ \text{?} ∈ \text{?} ∈ \text{?} \\ \text{?} \text{indicates text missing or illegible when filed} \qquad ( 3 )$$

and requests not immediately served by local caches are forwarded to the CDN or a box in another class.

The tracker also updates its forwarding policy at the end of an adaptation round. The updated values are subsequently used as inputs to the tracker's request forwarding algorithm for the next round. In particular, the tracker implements a routing scheme that ensures that the rate of requests for item c forwarded to d′∈ [symbol] ∪ {s} is precisely r_{c}^{dd′}. As mentioned above, the routing of requests in our scheme consists of two phases, request forwarding and service assignment. Turning now to the request forwarding phase a box b ∈ [symbol] generating a request for an item ∈ζ first checks if the gateway device generating the request already stores c, (e.g, c ∈ F_{b}.) If so, the request is served immediately and no downloading is necessary. If not, the requesting gateway device contacts the class tracker which determines whether the request should be forwarded to (a) another gateway device within the class, (b) a gateway device in another class, or (c) served directly by the CDN's infrastructure. If the tracker determines that the request is to be forwarded to class d′ (e.g. device in another class/domain), the request is routed to the tracker managing the other class. To select among these 3 outcomes, the tracker uses r^{d} as follows. A request is forwarded to d′∈ [symbol] ∪ {s} with a probability proportional to r_{c}^{dd′}. As a result, provided that Equation 3 is satisfied, requests forwarded from class d to d′ form independent Poisson processes with rates r_{c}^{dd′}.

In the service assignment phase, the class d tracker assigns a request for a content c to the gateway device in its class that is to serve the request. Requests can be local whereby the request is generated by a gateway device in [symbol] and deemed to be served locally during the forwarding phase, or external, whereby the request is generated by a box in a different class d′ and forwarded to the class d tracker by the tracker of d′. To assign requests to boxes, the tracker follows a uniform slot policy. Under this policy, an incoming request for content c is assigned to a gateway device selected among all gateway devices currently storing c and having an empty upload slot. Each such box is selected with a probability proportional to the number of its empty slots. Equivalently, the request is matched to a slot selected uniformly from all free upload slots of gateway devices storing c. For X_{b} the number of free slots of box b ∈ [symbol] , an incoming request for content c is mapped to a slot selected uniformly at random among the

$$\text{?} {X}_{b}$$

$$\text{?} \text{indicates text missing or illegible when filed}$$

slots or boxes that can serve this request.

It is possible that no free upload slots in the class exist when the request for c arrives

$$( i . e . , \text{?} {X}_{b} = 0 ) . \\ \text{?} \text{indicates text missing or illegible when filed}$$

In such a case, a request is re-routed to the CDN's infrastructure. Hence, not all requests for content c that arrive at class d are served by gateway devices in [symbol] . Thus, we let v_{c}^{d} be the loss probability of item c in class d which represents a probability that a request for c cannot be served and is re-routed to the CDN infrastructure. Requests for item c are then served with high probability (w.h.p.) in class d, if Equation 4 is satisfied.

$${lim}_{B \to ∞}^{d} {v}_{c}^{d} ( {B}^{d} ) = 0 , \qquad ( 4 )$$

Therefore, as the total number of boxes increases, the probability that a request for content c fails goes to zero when two necessary constraints as provided in Equations 5 and 6 to hold in class d ∈ [symbol] are:

$$\begin{matrix} \text{?} & ( 5 ) \\ {r}_{c}^{. d} < {B}^{d} {U}^{d} {p}_{c}^{d} , \\ ∀ c ∈ \text{?} , \\ \text{?} \text{indicates text missing or illegible when filed} & ( 6 )\end{matrix}$$

where

$${r}_{c}^{. d} = \sum \text{?} {r}_{c}^{{d}^{′} d}$$

$$\text{?} \text{indicates text missing or illegible when filed}$$

is the aggregate request rate for content [symbol] received by class d. The Constraint defined by Equation 5 states that the aggregate traffic load imposed on class d should not exceed the total upload capacity over all boxes and the constraint defined by Equation 6 states that the traffic imposed on d by requests for c should not exceed the total capacity of boxes storing c.

We now turn to the global optimization algorithm implemented by the optimization processor 304. The cost incurred when a request originating from class d is served by d′∈ [symbol] ∪ {s} is w^{dd′}. Moreover, the rate of requests for content [symbol] forwarded from d to d′ is r_{c}^{dd′}. Hence, the total traffic cost is

$${\sum }_{c ∈ \text{?}} {\sum }_{d ∈ \text{?}} [ {w}^{ds} {r}_{c}^{ds} + {\sum }_{{d}^{′}} ( {w}^{{dd}^{′}} {r}_{c}^{{dd}^{′}} ( 1 - {v}_{c}^{{d}^{′}} ) + {w}^{ds} {r}_{c}^{{dd}^{′}} {v}_{c}^{{d}^{′}} ) ] . \\ \text{?} \text{indicates text missing or illegible when filed}$$

This occurs because a fraction v_{c}^{d} requests for content [symbol] arriving at class d are re-routed to the CDN. In general, this is not a convex function, due to the loss probabilities v_{c}^{d}. However, given that Equation 4 is satisfied, the contribution of these losses becomes negligible for large system sizes having a large number of gateway devices in multiple different domains. The total system costs can thus be approximated as

$${\sum }_{d ∈ \text{?}} {F}^{d} ( {r}^{d} )$$

$$\text{?} \text{indicates text missing or illegible when filed}$$

as shown in Equation 7 which provides the total traffic cost generated by class d.

$${F}^{d} ( {r}^{d} ) = {\sum }_{c ∈ \text{?}} ( {w}^{ds} {r}_{c}^{ds} + {\sum }_{{d}^{′} ∈ \text{?}} {w}^{{dd}^{′}} {r}_{c}^{{dd}^{′}} ) \\ \text{?} \text{indicates text missing or illegible when filed} \qquad ( 7 )$$

The optimization processor 304 then needs to calculate a solution corresponding to the operator's minimal cost which is achieved in exemplary algorithmic form in Table 2

TABLE 2
Global Optimization Algorithm (GLOBAL)

| | | |
|---|---|---|
| Min. | Σ_{d}ε [symbol] F^{d}(r^{d}) | (8a) |
| subj. to | Σ_{c}ε [symbol] p_{c}^{d} = M^{d}, ∀d ∈ [symbol] | (8b) |
| | Σ_{d′}ε [symbol] r_{c}^{dd′} + r_{c}^{ds} = λ_{c}^{d}(1 −p_{c}^{d}), ∀c ∈ [symbol] ,d ∈ [symbol] | (8c) |
| | Σ_{c}ε [symbol] r_{c}^{.d} < R^{d}, ∀d ∈ [symbol] | (8d) |
| | r_{c}^{.d} < R^{d}p_{c}^{d}, ∀c ∈ [symbol] ,d ∈ [symbol] | (8e) |
| | r_{c}^{dd′} ≧ 0,r_{c}^{ds} ≧ 0, 1 ≧ p_{c}^{d} ≧ 0, ∀c ∈ [symbol] ,d,d′∈ [symbol] | |
| var. | r^{d},p^{d}, ∀d ∈ [symbol] | |

[symbol]

indicates data missing or illegible when filed

In the algorithm of Table 2, R^{d}=B^{d}U^{d} and is the total upload capacity in class d. The objective of this optimization is to minimize the total cost incurred by content transfers. Constraints (8b) and (8c) correspond to equations (2) and (3) and state that the full storage capacity of each class is used and that all requests are eventually served. Constraints (8d) and (8e) correspond to Equations 5 and 6, respectively.

What follows now is a discussion of the routing and placement policies implemented by the optimization algorithm 304. The policies are designed so that (a) trackers measure and adapt their policies to user demand, and (b) policy updates are computed in a distributed fashion, thus scaling well as the number of boxes increases. Most importantly, these policies converge to a solution of the algorithm of Table 2 to minimizes aggregate traffic costs.

The tracker device 300 solves the algorithm in Table 2 and determine replication and forwarding policies in a distributed fashion. In short, trackers exchange congestion signals and update p^{d}, r^{d} over several rounds at predetermined iterative times. We ensure that both are updated in a smooth fashion such that changes between two rounds are incremental and the system does not oscillate wildly. To address these issues, we use an interior point method that deals with the lack of strict convexity called the method of multipliers. Applied to the algorithm in Table 2, this implementation yields the algorithm summarized in Table 3.

TABLE 3
Decentralized solution to the global problem GLOBAL.

```
Tracker d at the end of round t:
  Obtain estimates of λ_{c}^{d}, r_{c}^{d} , c ∈ [symbol]  .
// Update dual variables
  ${s}_{tot}^{d} ← \text{?} ( \text{?} + \text{?} - \text{?} )$
  β^{d} ← β_{c}^{d} + θsₜₒₜ^{d}
  for each content c
    ${s}_{c}^{d} ← \text{?} ( \text{?} + \text{?} - \text{?} )$
    α_{c}^{d} ← α_{c}^{d} + θs_{c}^{d}
  end for
  Broadcast (α^{d}, β^{d}, s^{d}, sₜₒₜ^{d}) to other trackers d′ ∈ [symbol]
  Receive dual variables from all other trackers d′ ∈ [symbol]
// Update primal variables
  $( {r}^{d} , {p}^{d} , {z}^{d} , {y}^{d} ) ← {argmin }_{r}^{d} {LOCAL}^{d} ( {r}^{d} , {p}^{d} , {z}^{d} , {y}^{d} , α , β , s , {s}_{tot} )$
```

$\text{?} \text{indicates text missing or illegible when filed}$

If the tracker in class d correctly estimates λ_{c}^{d},r_{c}^{d} in each round, and that {θ(t)} [symbol] is a non-decreasing sequence of non-negative numbers. Then, under the adaptation algorithm in Table 3, r^{d}(t),p^{d}(t) converge to an optimal solution of the algorithm in Table 2 by performing smooth adaptations of r^{d},p^{d}.

The operations performed and messages exchanged by each tracker are listed below. The class d tracker maintains r^{d}(_{t),p}_{d}(t), α^{d}(t), β^{d}(t), the primal and dual variables of (8), as well as the slack variable

$${y}^{d} , {z}^{d} = [ {z}_{c}^{d} ] \text{?} , \\ \text{?} \text{indicates text missing or illegible when filed}$$

resulting from converting of (8d) and (8e) to equality constraints to generate Equations (10a)-(10c):

$$\begin{matrix} \text{?} {r}_{c}^{. d} + {y}^{d} = {R}^{d} , \\ ∀ d ∈ \text{?} & ( 10 a ) \\ {r}_{c}^{. d} + {z}_{c}^{d} = {R}^{d} {p}_{c}^{d} , \\ ∀ c ∈ \text{?} , {d}^{′} ∈ \text{?} & ( 10 b ) \\ {y}^{d} \geq 0 , \\ {z}_{c}^{d} \geq 0 , \\ ∀ c ∈ \text{?} , d ∈ \text{?} \\ \text{?} \text{indicates text missing or illegible when filed} & ( 10 c )\end{matrix}$$

Additionally, for every c ∈ [symbol] , the tracker maintains an estimate of λ_{c}^{d}, i.e., the request rate of c from boxes within its own class, as well as an estimate of r_{c}^{d} which represents the request rate for content c served by boxes in [symbol] . These can be estimated through appropriate counters or through more sophisticated moving-average methods (such as, e.g., EWMA). Using these estimates, the primal and dual variables are updated as follows. At the end of round t, the tracker in class d uses the estimates of r_{c}^{d} to see whether constraints of Equations (10a) and (10b) are violated or not. In particular, the tracker computes the quantities:

$${s}_{tot}^{d} ( t ) = \text{?} \text{?}$$

$${s}_{c}^{d} ( t ) = \text{?} \text{?} , \\ ∀ c ∈ \text{?}$$

$$\text{?} \text{indicates text missing or illegible when filed}$$

and updates the dual variables as follows:

$${β}^{d} ( t ) = {β}^{d} ( t - 1 ) + θ ( t ) {s}_{tot}^{d} ( t )$$

$${α}_{c}^{d} ( t ) = {α}_{c}^{d} ( t - 1 ) + θ ( t ) {s}_{c}^{d} ( t ) , \\ ∀ c ∈ \text{?}$$

$$\text{?} \text{indicates text missing or illegible when filed}$$

where {θ(t)} [symbol] are positive and non-decreasing. Subsequently, the tracker broadcasts to every other tracker in [symbol] its congestion signals α^{d}(t), β^{d}(t),s^{d}(t),sₜₒₜ^{d}(t). This entails the exchange of 2| [symbol] (| [symbol] +1) values, in total. Furthermore, for any d,d′∈ [symbol] , let Gₜₒₜ^{dd′}(r^{d},y^{d})=Σ_{c}r_{c}^{dd′}+1_{d-d′}y^{d}, and G_{c}^{dd′}(r^{d}, p^{d}, z^{d})=r_{c}^{dd′}+1_{d=d′}(z_{c}^{d}−R^{d}p_{c}^{d}). Intuitively, these capture the “contribution” of the primal variables of class d to the constraints of Equations (10a) and (10b) of class d′. After the tracker in class d has received all the messages sent by other trackers, it solves the following quadratic program:

$${LOCAL}^{d} \\ ( {r}^{d} ( t ) , {p}^{d} ( t ) , {z}^{d} ( t ) , {y}^{d} ( t ) , α ( t ) , β ( t ) , s ( t ) , {s}_{tot} ( t ) )$$

$$Min . \\ {F}^{d} ( {r}^{d} ) + {\sum }_{{d}^{′}} {β}^{{d}^{′}} ( t ) {G}_{tot}^{{dd}^{′}} ( {r}^{d} , {y}^{d} ) + {\sum }_{{d}^{′} , c} {α}_{c}^{{d}^{′}} ( t ) {G}_{c}^{{dd}^{′}} ( {r}^{d} , {p}^{d} , {z}^{d} ) + \text{?} {\sum }_{{d}^{′}} [ \begin{matrix}{( {G}_{tot}^{{dd}^{′}} ( {r}^{d} - {r}^{d} ( t ) , {y}^{d} - {y}^{d} ( t ) ) + {s}_{tot}^{{d}^{′}} ( t ) )}^{2} + \\ {\sum }_{c} {( {G}_{c}^{{dd}^{′}} ( \begin{matrix}{r}^{d} - {r}^{d} ( t ) , {p}^{d} - \\ {p}^{d} ( t ) , {z}^{d} - {z}^{d} ( t )\end{matrix} ) + {s}_{c}^{{d}^{′}} ( t ) )}^{2}\end{matrix} ]$$

$$s . t . \\ ( {r}^{d} , {p}^{d} , {z}^{d} , {y}^{d} ) ∈ {\text{?}}^{d} , \\ ∀ d ∈ \text{?}$$

$$var {r}^{d} , {p}^{d} , {z}^{d} , {y}^{d} , d ∈ \text{?}$$

$$\text{?} \text{indicates text missing or illegible when filed}$$

where [symbol] is the set of quadruplets (r^{d},p^{d}, y^{d}, z^{d}) defined by Equations (8b) and (8c) as well as the non-negativity constraints. LOCAL^{d} thus receives as input all the dual variables α, β, the congestion variables s^{d}, sₜₒₜ^{d}, as well as all the local primal variables at round t. The last four are included in the quadratic terms appearing in the objective function, and ensure the smoothness of the changes to the primal variables from one round to the next.

Through an appropriate exchange of congestion signals, trackers can solve the algorithm in Tabel 2 in a distributed fashion. However, the objective is to determine an approximation of the actual traffic because requests reaching a class may be “dropped” and redirected to the CDN infrastructure. Thus, it is important for the optimization processor 304 to generate and implement a content placement algorithm. The optimization processor 304 determines conditions that are necessary and sufficient for requests to be fulfilled with a high probability when the trackers implement the uniform slot service assignment between the designated slots and the auxiliary slots.

Consider a collection of contents [symbol] such that [symbol] =M^{d}. Let

$$\text{?} = \{ b ∈ \text{?} \text{:} {ℱ}_{b} = ℱ \}$$

$$\text{?} \text{indicates text missing or illegible when filed}$$

be the set of gateway devices in the class that store exactly [symbol] . These sets partition [symbol] into sub-classes, each comprising gateway devices that store identical contents. The number of gateway devices B=| [symbol] | approaches infinity while scaling both the request arrival rates r_{c}^{d} and the size of the subclasses

$$\text{?} = \vert \text{?} \vert$$

$$\text{?} \text{indicates text missing or illegible when filed}$$

proportionally to B. That is, the quantities r_{c}^{d}/B, B [symbol] ^{d}/B are constants that do not depend on B as the latter increases. Thus, as B increases, the aggregate content demand and the storage and upload capacities grow proportionally with B.

If requests are assigned according to the uniform slot policy, then requests for every content c ∈ [symbol] are served if and only if Equation 11 is satisfied.

$${\sum }_{c ∈ A}^{ } {r}_{c}^{. d} < \text{?} \text{?} {U}^{d} , \\ for all A ⊆ \text{?} , \\ \text{?} \text{indicates text missing or illegible when filed} \qquad ( 11 )$$

Equation (11) stipulates that for any set of items A ⊂ [symbol] the arrival rate of requests for these items does not exceed the total upload capacity of class d gateway devices storing these items. Thus, it is clear that Equation (11) is necessary for Equation (4) to hold. Alternatively, when the service assignment policy used is the so-called repacking policy, at the arrival of a request, repacking re-assigns requests already served by gateway devices of the domain in order to accommodate this request. Performing this “repacking” requires finding a maximum matching in a bipartite graph of 2B^{d}U^{d} nodes. However, the uniform slot policy is easier to implement than repacking

The content placement performed by the optimization processor 304 of the tracker should be such that condition in Equation (11) is satisfied. The present system advantageously resolves this despite this condition consisting of a number of inequalities that is exponential in the catalog size [symbol] . Specifically, if the conditions (8d) and (8e) of the algorithm in Table 2 are true, a content placement scheme that satisfies Equation 11 is possible. This simplifies the design of the content placement algorithm implemented by optimization processor 304 because we only need to ensure that the O(| [symbol] | | [symbol] |) constraints (8d) and (8e) hold, rather than the exponentially many constraints in Equation

11.

The optimization processor maps contents data to respective sections of the memory module (204 in FIG. 2) of respective gateway devices within the class or domain in such a manner to satisfy Equation 11. At each round, the optimization processor 304 reshuffles cache contents in respective memory modules of respective gateway devices within the class to reach a desired placement scheme with as few item transfers as possible. For example, if (8d) and (8e) hold, there exists a simple placement scheme—i.e., a set of cache contents {F_{b}} [symbol] —that satisfies Equation 11. For every box b ∈ [symbol] , we identify a first partition (206 in FIG. 2) of the memory module (204 in FIG. 2) as a designated slot. We denote the content of this slot by D_{b}. The remaining contents of the memory module is stored in the second partion (208 in FIG. 2) which represents the auxiliary slots. The remaining contents of b are denoted by L_{b}= [symbol] \{D_{b}}. For all c ∈ [symbol] , let

$${s}_{c}^{d} = \{ b ∈ \text{?} \text{:} {D}_{b} = c \}$$

$$\text{?} \text{indicates text missing or illegible when filed}$$

be the set of boxes storing c in their designated slot. If a sufficient number boxes store c in their designated slot, then Equation 11 is satisfied and there exists a placement policy such that all requests for the particular content c will be fulfilled by a gateway device in a manner that minimizes transmission costs associated with acquisition of the content.

Hence, to ensure that Equation (11) is satisfied, at least r_{c}^{d}/U^{d} boxes should store c in their designated slot. We call such a placement scheme a designated slot placement. On the other hand, the fraction of boxes that store c in any slot must not exceed p_{c}^{d}. It is possible to place contents in each designated slot to ensure that both constraints are satisfied when (8d) and (8e) hold. If (8d) and (8c) hold, ensuring that requests for all contents are served w.h.p. in class d is achieved constructing a designated slot placement. Such a placement stores content c in the designated slot of at least q_{c}^{d}B^{d} boxes, where q_{c}^{d}B^{d} are determined, the remaining slots are used to achieve an overall replication ratio of p_{c}^{d} within the class. Below, we describe an algorithm that, given ratios q_{c}^{d} and p_{c}^{d}, places content in class d in a way that these ratios are satisfied. For simplicity, we drop the superscript d in the remainder of this section, referring to content placement in a single class.

At the end of each adaptation round, the tracker is aware of the initial content placement { [symbol] } [symbol] over B boxes in set [symbol] , prior to the adaptation, as well as the target (i.e., adapted) replication ratios p_{c}′ and q_{c}′, c ∈ [symbol] . An exemplary placement algorithm is provided in Table 4 and receives these as inputs and outputs a new content placement { [symbol] } [symbol] in which q_{c}′ boxes store c in their designated slot, while approximately p_{c}′B boxes store c overall. Crucially, the placement requires as few cache changes as possible.

We assume that q_{c}′B and p_{c}′B are integers and q_{c}, p_{c} are the corresponding designated slot and overall fractions in the input placement {F_{b}} [symbol] , Let π_{c}=p_{c}−q_{c}, π′_{c}−q′_{c}. A lower bound on the cache modification operations needed to attain the target replication ratios q′_{c} and p′_{c} is given by B (α+β)/2, where α=Σ_{c}|q_{c}−q′_{c}|, β=Σ_{c}|π_{c}−π′_{c}|.

TABLE 4
Placement algorithm

```
Input: Initial placement {F_{b}}_{b}ε [symbol]  and target ratios q_{c}′, p_{c}′
Let A⁺ := {c ∈ [symbol]  : q_{c} > q_{c}′}, A⁻ := {c :∈ [symbol] : q_{c} < q_{c}′};
while there exists b ∈ [symbol]  s.t. D_{b} ∈ A⁺ and L_{b} ∩ A⁻ ≠
  Pick c ∈ L_{b} ∩ A⁻, and swap it locally with the content of D_{b}.
  Update q, π, A⁺,A⁻ accordingly
while there exists b ∈ [symbol]  s.t. D_{b} ∈ A⁺ and L_{b} ∩ A⁻ ≠
  Pick c ∈ A⁻ and place c in the designated slot D_{b};
  Update q, π, A⁺,A⁻ accordingly
Let C⁺ := {c : π_{c} > π_{c}′}; C⁺ := {c : π_{c} < π_{c}′};
C⁰ := [symbol] \ (C⁺ ∪ C⁻).
Let G := { b ∈ [symbol]  s.t. C₊ ∩ L_{b}≠ and C₋\ (D_{b} ∪ L_{b})≠};
while (G≠) or (there exists c ∈ C⁻ s.t. (π_{c} − π_{c}′)B≧ 2)
  if (G≠) then
    Pick any b ∈ G
    Replace some c ∈ C₊ ∩ L_{b} with some c′∈ C₋\ (D_{b} ∪ L_{b});
  else
    Pick c ∈ C⁻ s.t. (π_{c} − π_{c}′)B ≧ 2.
    Find a box b that does not store c.
    Pick c′∈ C₀ ∩ L_{b} and replace c′ with c.
update G, π, C⁺, C⁻, C⁰ accordingly. [symbol]
indicates data missing or illegible when filed
```

The content placement algorithm in Table 4 leads to a content replication {F′_{b}} [symbol] in which exactly q_{c}′B boxes store c in their designated slot, and p_{c}″B boxes store c overall, where Σ_{c}|p_{c}′−p_{c}″| B<2M, and |p_{c}′−p_{c}″| B≦1, for all c ∈ [symbol] . The total number of write operations is at most B[α+(M−1)(α+β)]/2. In summary, the algorithm produces a placement in which at most 2M items are either under or over-replicated, each by only one replica. Most importantly, the placement is achieved with at most O(B(α+β)) write operations, which is order-optimal. If replication ratios change gradually (and, thus, α and β are small), as ensured by our policy adaptation, the algorithm does not perform a large number of cache changes.

The algorithm proceeds in three phases. In the first phase, the algorithm modifies the designated slots to reach the desired ratios q′. To do so, the algorithm picks any over-replicated content c in set A₊={c:q_{c}>q′_{c}}. For any user holding c in its designated slot, it checks whether it holds in its normal (e.g. auxiliary) slots an under-replicated content c′∈ A₋={c:q_{c}<q′_{c}}. If such content exists, it renames the corresponding slot as “designated” and the slot holding c as “normal”. This is repeated until an under-replicated content c′ cannot be found within the normal cache slots of boxes storing some c ∈ A₊. If there still are over-replicated items in A₊, some c′∈ A₋ is selected arbitrarily and overwrites c within the designated slot. At the end of this phase, the replication rates within the designated slots have reached their target B [symbol] , and the resulting caches are free of duplicate copies. Also, after these operations, the intermediate replication rates π_{c}″ within the normal cache slots verify |Bπ_{c}−Bπ″_{c}|≦|Bq_{c}−Bq′_{c}|.

In the second phase, the algorithm begins transforming these intermediate replication rates π_{c}″ into π_{c}′ . To this end, we distinguish contents c that are over-replicated, under-replicated and perfectly replicated by introducing C₊={c:π_{c}<π_{c}′}, C₋={c:π_{c}=π_{c}′}, and C₀={c:π_{c}=π_{c}′}.

C₊={c:π_{c}>π_{c}′}, C₋={c:π_{c}<π_{c}′}, C₀={c:π_{c}=π_{c}′}.

For any box b, if there exists c ∈C₊ ∩ L_{b}, and c′∈ C₋\(D_{b} ∪ L_{b}), the algorithm replaces c by c′ within L_{b}. This operation is termed a greedy reduction. Greedy reductions are repeated until the algorithm arrives at a configuration where no such changes are possible thereby terminating the second phase of the algorithm. At that point, for any box b such that C₊∩L_{b} is not empty, necessarily C₋⊂ (L_{b} ∩D_{b}). Hence, the size of C₋ is at most M−1. If any of the elements in C₋ is under replicated by at least two replicas, the algorithm enters its third phase.

In the third phase, the algorithm picks some content c′ that is under-replicated by at least 2 replicas, and finds a user b which does not hold c′, i.e. c′ ∈ C₋\(D_{b} ∩L_{b}). It also selects some content c within C₋∩ L_{b}: such content must exist, since |C₋|≦M−1, and C₋∩ L_{b} ⊂ C₋\{c′} has size strictly less than M−1, the size of L_{b}; the remaining content c must belong to C₀ since otherwise we could have performed a greedy reduction. The algorithm then replaces content c by content c′. We call this operation a switch. This augments the size of set C₋: indeed content c is now under-replicated (one replica missing). The algorithm then tries to do a greedy reduction, i.e., a replacement of an over-replicated content by c if possible. If not, it performs another switch, i.e., by identifying some content under-replicated by at least 2, and creating a new replica in place of some perfectly replicated item, thereby augmenting the size of C₋. Hence, in at most M−1 steps, the algorithm inflates the size of C₋ to at least M, at which stage we know that a greedy reduction can be performed. This alteration between greedy reductions and switches is repeated until the size of C₋ is at most M−1, and each such content is missing exactly one replica.

When compared to frequently used caching strategies as well as a request routing heuristic approaches, the optimization and placement algorithms executed by the optimization processor of the tracker produces superior results. The present system advantageously provides a solution to regulate cross-traffic and minimize content delivery costs in decentralized CDNs. The present system advantageously provides an optimal request routing scheme that can accommodate user demands and an effective service mapping algorithm that may be implemented by each operator of a CDN. The system further provides an adaptive content caching algorithm with low operational costs.

An exemplary embodiment of the system discussed above may include device for tracking and positioning content within a domain including a plurality of devices that provide content data to users. The tracking device may include a communication interface that receives requests for content from respective ones of the plurality of devices and an optimization processor that analyzes all requests for each piece of content, and determines at least one of an actual request rate and a target request rate for each piece of content and, in response to the determination of the actual and target request rates, instructs individual devices of the plurality of devices to store respective pieces of content in a memory. In one embodiment, the optimization processor periodically updates the actual request rate and target request rate for each piece of content and evaluate contents stored in the memory based on the updated actual and target request rates and automatically adjusts the content stored in the memory of the individual devices based on the periodic evaluation.

In another embodiment, the optimization processor instructs respective individual devices to store content data in a designated slot based on the actual request rate for the content data and an auxiliary slot based on the target request rate for the content data. The optimization processor may removes content from a designated slot when the actual request rate falls below a predetermined value. In another embodiment, the optimization processor ranks the individual pieces of content based on the actual request rate and removes content from respective designated slots when the request rate for the particular piece of content falls below a threshold rank.

In another embodiment, the the communication interface of the device periodically receives characteristic data from other domains associated with content requested within each other domain. The characteristic data includes at least one of (a) a congestion metric identifying an amount of network congestion within a respective domain; (b) a total actual request rate associated with each piece of content; and a total target request rate associated with each piece of content.

In another embodiment, the optimization processor uses the received characteristic data instructs individual devices of the plurality of devices to store respective pieces of content in a memory. The optimization processor uses the characteristic data received from other domains to determines a fulfillment metric identifying the number of requests for each piece of content being fulfilled by devices in the domain, devices in other domains and a content provider server.

In another embodiment, the optimization processor automatically modifies a number of copies of a particular piece of content stored within one of the designated slot and auxiliary slots of the memory based on the fulfillment metric to ensure that the number of requests for a respective piece of content being fulfilled by devices within the domain is greater than the number of requests being fulfilled by each of devices in other domains and content provider server.

In another embodiment, the communication interface receives all requests for each piece of content; and the optimization processor determines which of the plurality of individual devices within the domain will fulfill each received request. The optimization processor, in response to determining that a respective request for content cannot be fulfilled by an individual device within the domain, directs the requesting user to one of (a) an individual device for providing content in a different domain or (b) a content provider server.

In another embodiment, the optimization processor monitors available upload capacity on each of the individual devices within the domain to determine which of the individual devices having respective requested content can fulfill a request for the respective requested content at a given time. The optimization processor may also calculate a replication ratio for each piece of content stored on the individual devices within the domain; and periodically modifies the replication ratio for respective pieces of content based on the actual request rate and target request rate for the respective piece of content.

Additionally, the methods may be implemented by instructions being performed by a processor, and such instructions may be stored on a processor or computer-readable media such as, for example, an integrated circuit, a software carrier or other storage device such as, for example, a hard disk, a compact diskette, a random access memory (“RAM”), a read-only memory (“ROM”) or any other magnetic, optical, or solid state media. The instructions may form an application program tangibly embodied on a computer-readable medium such as any of the media listed above. As should be clear, a processor may include, as part of the processor unit, a computer-readable media having, for example, instructions for carrying out a process. The instructions, corresponding to the method of the present invention, when executed, can transform a general purpose computer into a specific machine that performs the methods of the present invention.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A device for tracking and positioning content within a domain including a plurality of devices that provide content data to users, the device comprising:
a communication interface that receives requests for content from respective ones of the plurality of devices;
an optimization processor that analyzes all requests for each piece of content, and determines at least one of an actual request rate and a target request rate for each piece of content and, in response to the determination of the actual and target request rates, instructs individual devices of the plurality of devices to store respective pieces of content in a memory.

2. The device of claim 1, wherein
the optimization processor periodically updates the actual request rate and target request rate for each piece of content and evaluate contents stored in the memory based on the updated actual and target request rates.

3. The device of claim 2, wherein
the optimization processor automatically adjusts the content stored in the memory of the individual devices based on the periodic evaluation.

4. The device of claim 1, wherein
the optimization processor instructs respective individual devices to store content data in a designated slot based on the actual request rate for the content data and an auxiliary slot based on the target request rate for the content data.

5. The device of claim 4, wherein
the optimization processor removes content from a designated slot when the actual request rate falls below a predetermined value.

6. The device of claim 1, wherein
the optimization processor ranks the individual pieces of content based on the actual request rate and removes content from respective designated slots when the request rate for the particular piece of content falls below a threshold rank.

7. The device of claim 1, wherein
the communication interface periodically receives characteristic data from other d domains associated with content requested within each other domain.

8. The device of claim 7, wherein
the characteristic data includes at least one of (a) a congestion metric identifying an amount of network congestion within a respective domain; (b) a total actual request rate associated with each piece of content; and a total target request rate associated with each piece of content.

9. The device of claim 7, wherein
the optimization processor uses the received characteristic data instructs individual devices of the plurality of devices to store respective pieces of content in a memory.

10. The device of claim 7, wherein
The optimization processor uses the characteristic data received from other domains to determines a fulfillment metric identifying the number of requests for each piece of content being fulfilled by devices in the domain, devices in other domains and a content provider server.

11. The device of claim 10, wherein
the optimization processor automatically modifies a number of copies of a particular piece of content stored within one of the designated slot and auxiliary slots of the memory based on the fulfillment metric to ensure that the number of requests for a respective piece of content being fulfilled by devices within the domain is greater than the number of requests being fulfilled by each of devices in other domains and content provider server.

12. The device of claim 1, wherein
the communication interface receives all requests for each piece of content; and
the optimization processor determines which of the plurality of individual devices within the domain will fulfill each received request.

13. The device of claim 12, wherein
the optimization processor, in response to determining that a respective request for content cannot be fulfilled by an individual device within the domain, directs the requesting user to one of (a) an individual device for providing content in a different domain or (b) a content providers server.

14. The device of claim 12, wherein
the optimization processor monitors available upload capacity on each of the individual devices within the domain to determine which of the individual devices having respective requested content can fulfill a request for the respective requested content at a given time.

15. The device of claim 1, wherein
the optimization processor calculates a replication ratio for each piece of content stored on the individual devices within the domain; and
periodically modifies the replication ratio for respective pieces of content based on the actual request rate and target request rate for the respective piece of content.

16. A method of tracking and positioning content within a domain including a plurality of devices that provide content data to users, the method comprising the activities of:
receiving requests for content from respective ones of the plurality of devices;
analyzing all requests for each piece of content;
determining at least one of an actual request rate and a target request rate for each piece of content; and
instructing individual devices of the plurality of devices to store respective pieces of content in a memory in response to the determination of the actual and target request rates.

17. The method of claim 16, further comprising
periodically updating the actual request rate and target request rate for each piece of content; and
evaluating content stored in the memory based on the updated actual and target request rates.

18. The method of claim 17, further comprising
automatically adjusting the content stored in the memory of the individual devices based on the periodic evaluation.

19. The method of claim 16, further comprising
instructing respective individual devices to store content data in a designated slot based on the actual request rate for the content data and an auxiliary slot based on the target request rate for the content data.

20. The method of claim 19, further comprising
removing content from a designated slot when the actual request rate falls below a predetermined value.

21. The method of claim 16, further comprising
ranking the individual pieces of content based on the actual request rate and removes content from respective designated slots when the request rate for the particular piece of content falls below a threshold rank.

22. The method of claim 1, wherein
periodically receiving characteristic data from other domains, the characteristic data being associated with content requested within each other domain.

23. The method of claim 22, wherein
the characteristic data includes at least one of (a) a congestion metric identifying an amount of network congestion within a respective domain; (b) a total actual request rate associated with each piece of content; and a total target request rate associated with each piece of content.

24. The method of claim 22, further comprising
using the received characteristic data to instruct individual devices of the plurality of devices to store respective pieces of content in a memory.

25. The method of claim 22, further comprising
using the characteristic data received from other domains to determines a fulfillment metric identifying the number of requests for each piece of content being fulfilled by devices in the domain, devices in other domains and a content provider server.

26. The method of claim 22, further comprising
modifying a number of copies of a particular piece of content stored within one of the designated slot and auxiliary slots of the memory based on the fulfillment metric to ensure that the number of requests for a respective piece of content being fulfilled by devices within the domain is greater than the number of requests being fulfilled by each of devices in other domains and content provider server.

27. The method of claim 1, further comprising
receiving all requests for each piece of content; and
determining which of the plurality of individual devices within the domain will fulfill each received request.

28. The method of claim 27, further comprising
directing the requesting user to one of (a) an individual device for providing content in a different domain or (b) a content providers server in response to determining that a respective request for content cannot be fulfilled by an individual device within the domain,

29. The method of claim 27, further comprising
monitoring available upload capacity on each of the individual devices within the domain to determine which of the individual devices having respective requested content can fulfill a request for the respective requested content at a given time.

30. The method of claim 16, further comprising
calculating a replication ratio for each piece of content stored on the individual devices within the domain; and
periodically modifying the replication ratio for respective pieces of content based on the actual request rate and target request rate for the respective piece of content.
